(19) United States
(12) Patent Application Publication
(10) Pub. No.: US 2016/0299349 A1
(43) Pub. Date: Oct. 13, 2016

(54) LENS DRIVING DEVICE AND CAMERA MODULE INCLUDING THE SAME

(71) Applicant: SAMSUNG ELECTRO-MECHANICS CO., LTD., Suwon-si (KR)

(72) Inventor: Yong Wan CHO, Suwon-si (KR)

(73) Assignee: SAMSUNG ELECTRO-MECHANICS CO., LTD., Suwon-si (KR)

(21) Appl. No.: 15/041,438

(22) Filed: Feb. 11, 2016

(30) Foreign Application Priority Data
Apr. 10, 2015 (KR) 10-2015-0051127

(51) Int. Cl. G02B 27/64; H04N 5/225; G02B 13/00; G03B 5/02; G03B 13/36; G02B 7/09

(52) U.S. Cl. CPC G02B 27/646; G03B 13/36; G02B 7/09; G02B 13/001; G03B 5/02; H04N 5/2254; H04N 5/2253

(57) ABSTRACT

A lens driving device includes a lens barrel; a lens disposed in the lens barrel; a plurality of magnets disposed on an external surface of the lens barrel; a guide member coupled to the lens barrel configured to move the lens barrel in an optical axis direction; a first coil disposed on one side of the guide member opposite to one of the plurality of magnets; a base supporting the guide member configured to move the guide member in a direction orthogonal to the optical axis direction; and a second coil disposed on a side wall of the base opposite to a magnet which is not opposite to the first coil.

### CROSS-REFERENCE TO RELATED APPLICATION

This application claims the benefit under 35 USC 119(a) of Korean Patent Application No. 10-2015-0051127 filed on Apr. 10, 2015, with the Korean Intellectual Property Office, the entire disclosure of which is incorporated herein by reference for all purposes.

### BACKGROUND

1. Field

The following description relates to a lens driving device and a camera module including the same.

2. Description of Related Art

As small camera modules have become multifunctional and compact, the application of small camera modules has gradually expanded to mobile devices such as mobile phones, notebook PCs, and tablet PCs.

In general, the camera module may include an optical system including a lens, an auto-focusing apparatus moving the optical system to an optical axis to control a focus, an image sensor (for example, CMOS sensor or CCD sensor) converting an image obtained by photographing a subject into an electrical signal.

Further, an optical image stabilizer (for example, OIS system) correcting user hand-shake may be additionally provided to remove image blurring through the camera having moved or been shaken due to factors such as user hand-shake while capturing a static or moving image.

However, the auto-focusing apparatus and the optical image stabilizer included in the existing camera module have a complicated configuration and require a large number of components, leading to an assembly process being relatively complicated while increasing a volume of a camera module, thereby increasing manufacturing costs.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a lens driving device and a camera module including the same which includes an auto-focusing function and an optical image stabilization function with a reduced size by reducing the number of components used therein. The lens driving device includes a lens barrel; a lens disposed in the lens barrel; a plurality of magnets disposed on an external surface of the lens barrel; a guide member coupled to the lens barrel configured to move the lens barrel in an optical axis direction; a first coil disposed on one side of the guide member opposite to one of the plurality of magnets; a base supporting the guide member configured to move the guide member in a direction orthogonal to the optical axis direction; and a second coil disposed on a side wall of the base opposite to a magnet which is not opposite to the first coil.

The lens driving device includes an auto-focusing driver, disposed on one side of the guide member, includes a first printed circuit board; the first coil coupled to one side of the first printed circuit board; and a yoke fixed to two of the leg parts and another side of the first printed circuit board.

The lens driving device includes a hand-shake prevention driver, disposed on a side wall of the base, includes a second printed circuit board fixed to the side wall, wherein the second coil is coupled to one side of the second printed circuit board.

In another general aspect, a camera module includes a lens driving device; and an image sensor mounted in a base and corresponding to a position of a lens of the lens driving device, wherein the lens driving device includes a lens barrel; a plurality of magnets disposed on an external surface of the lens barrel; a guide member coupled to the lens barrel configured to move the lens barrel in an optical axis direction; a first coil disposed on one side of the guide member opposite to one of the plurality of magnets; the base configured to support the guide member and move the guide member in a direction orthogonal to the optical axis direction; and a second coil disposed on a side wall of the base opposite to a magnet which is not opposite to the first coil.

In another general aspect, a lens driving device includes a lens barrel; magnets disposed on an external surface of the lens barrel; a plurality of concave parts, extending in an optical axis direction, disposed in the lens barrel between each of the magnets, respectively; a guide member, configured to support the lens barrel, comprising a main body and a plurality of leg extending in the optical axis direction from the main body, wherein the plurality of legs correspond to the plurality of concave parts; a first coil disposed on a side of the guide member corresponding to one of the magnets; and a base configured to support the guide member.

The lens driving device further includes a stopping part disposed on each of the plurality of legs, distal from the main body, a stopper disposed on each the lens barrel, adjacent to the concave parts, and a first ball member disposed between the plurality of legs and the plurality of concave parts, wherein the stopping part and the stopper are configured to prevent the first ball member from separating. The guide member supports the stopping part and first ball member, and the stopping part and first ball member support lens barrel. Thus, the lens barrel is supported by the guide member through the ball members and stopping and stoppers.

Other features and aspects will be apparent from the following detailed description, the drawings, and the claims.

### BRIEF DESCRIPTION OF DRAWINGS

FIG. 1 is a perspective view of a camera module according to an embodiment;

FIG. 2 is a perspective view of a lens driving device according to an embodiment;

FIG. 3 is an exploded perspective view of FIG. 1; and

FIG. 4 is a perspective view of a guide member illustrated in FIGS. 2 and 3.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

It will be apparent that though the terms first, second, third, etc. may be used herein to describe various members, components, regions, layers and/or sections, these members, components, regions, layers and/or sections should not be limited by these terms. These terms are only used to distinguish one member, component, region, layer or section from another region, layer or section. Thus, a first member, component, region, layer or section discussed below could be termed a second member, component, region, layer or section without departing from the teachings of the exemplary embodiments.

Unless indicated otherwise, a statement that a first component is “on” a second component or element is to be interpreted as covering both a case where the first component directly contacts the second component or element, and a case where one or more other components are disposed between the first component and the second component or element.

Words describing relative spatial relationships, such as “below”, “beneath”, “under”, “lower”, “bottom”, “above”, “over”, “upper”, “top”, “left”, and “right”, may be used to conveniently describe spatial relationships of one device or elements with other devices or elements. Such words are to be interpreted as encompassing a device oriented as illustrated in the drawings, and in other orientations in use or operation. For example, an example in which a device includes a second component disposed above a first component based on the orientation of the device illustrated in the drawings also encompasses the device when the device is flipped upside down in use or operation.

The following description relates to a technology of combining an optical image stabilizer with an auto-focusing apparatus by interposing a guide member to move a lens barrel in an optical axis direction and a direction intersecting an optical axis direction, thereby reducing the number of components required in a camera module to allow for miniaturizing the camera module.

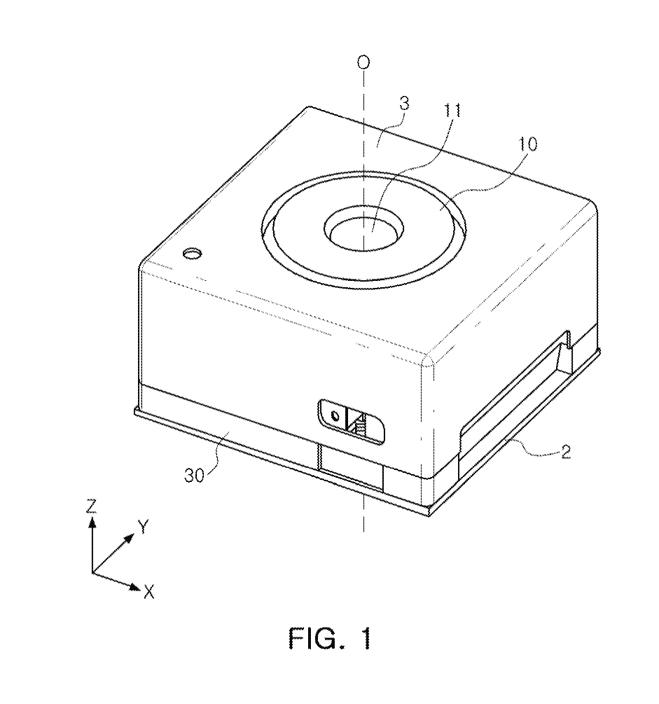

In order to clearly describe the embodiments in the following description, a Z direction illustrated in FIG. 1 refers to an optical axis direction in which light travel towards a lens 11 perpendicular to the optical axis O. An X direction and a Y direction (or X-Y plane) refer to a direction orthogonal to the optical axis extending. In other words the X-Y plans disposed at a right angle with respect to an optical axis direction.

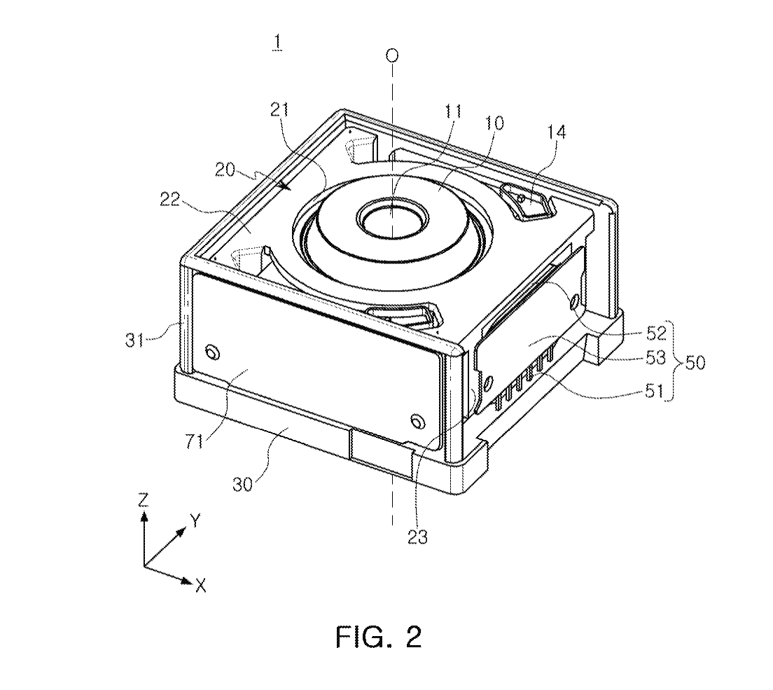

Referring to FIGS. 1 through 3, the camera module according to an embodiment includes a lens driving device 1 and an image sensor 2 mounted in a base 30 corresponding to a lens 11 of the lens driving device. The lens driving device 1 drives the lens 11 along the optical axis direction or the direction orthogonal to the optical axis to reduce distortions an image focused on an image sensor 2.

A shield case 3 having a through hole is coupled to an external surface of the lens driving device 1 to form an exterior of the camera module and protect internal components.

The lens driving device 1 includes a lens barrel 10 having the lens 11 provided therein and supporting a plurality of magnets 12 and 13 on an external surface thereof; a guide member 20 coupled to the lens barrel 10 to guide the lens barrel in the optical axis direction; a first coil 52 disposed on one side of the guide member opposite to at least one magnet 12 of the plurality of magnets; a base 30 supporting the guide member to move the guide member in a direction intersecting the optical axis direction; and a second coil 72 disposed on a side wall 31 of the base opposite to a magnet 13.

The lens barrel 10 includes the lens 11 or the plurality of lenses provided therein and includes the plurality of magnets 12 and 13 supported on the external surface thereof. The lens barrel 10 has a hollow cylindrical shape to receive at least one lens 11 for imaging a subject therein. The plurality of lenses are arranged in the lens barrel along the optical axis.

The plurality of lenses 11 are stacked in the lens barrel 10. The number of lenses may be varied according to a design of the camera module, and the respective lenses have optical characteristics such as the same refractive index, different refractive indices, or any combination thereof.

The lens barrel 10 moves in the optical axis direction for auto-focusing. As such, to move the lens barrel 10 in the optical axis direction, the lens barrel is movably disposed inside the guide member 20 and a first ball member, or bearing 40 is interposed between one surface of the guide member and one surface of the lens barrel opposite one surface of the guide member for stable movement and friction prevention.

The external surface of the lens barrel 10 has a guide groove (not illustrated) selectively guiding the movement of the first ball member 40 in parallel with the optical axis direction between the magnets 12 and 13.

Additionally, a stopper 14 for regulating and controlling a range of motion of the first ball member to prevent the first ball member 40 interposed between the guide member 20 and the lens barrel 10 from separating. The stopper is disposed on the lens barrel 10, above the first ball member 40. As a result, the stopper 14 prevents the first ball member 40 from separating when the lens barrel 10 is moved in the optical axis direction. Thus, the lens barrel can move smoothly without any danger of separation of the first ball member 40 in the optical axis direction.

An auto-focusing driver 50 is disposed on one side of the guide member 20 so that the lens barrel 10 may be driven in the optical axis direction while inside the guide member 20.

The guide member 20 includes a main body 22 having an approximately square shape. An opening part 21 penetrates through the main body 22 along the optical axis direction. A plurality of leg parts 23 extends in parallel with the optical axis direction from each corner of the main body 22. Here, a material or a manufacturing method of the guide member 20 may be varied. However, considering the ease and cost of manufacturing, plastic injection may be one method of manufacturing the guide member 20.

The number of leg parts 23 and a disposition interval between the leg parts may be varied. As described below, the appropriate number of leg parts may extend from the main body 22 at an appropriate interval so that ball members connected to each leg part may facilitate smooth movement of the guide member 20, relative to the lens barrel 10 or the base 30, or both.

Side surfaces of at least some of the leg parts 23 of the guide member 20, facing each other, are provided with concave parts 24 extending in a length direction of the leg part, or Z direction, and at least one side of the concave part has a stopping part 25. The stopping part 25 is disposed to correspond to the stopper 14 disposed on the one side of the lens barrel 10. The stopping part 25 and stopper 14 regulate the range of movement of the first ball member 40 to prevent separation of the first ball member 40.

The first ball member 40 is disposed in the concave part 24 of the leg part 23 and configured to roll while contacting the external surface of the lens barrel 10, or a guide groove formed therein.

Even when the first ball members 40 are provided in only a pair of leg parts 23 positioned on one side of the guide member 20 provided with the auto-focusing driver 50, the lens barrel 10 may be sufficiently supported when driven in the optical axis direction from an inner side of the guide member. Further, the first ball member 40 may be provided in another pair of leg parts 23 positioned on the other side of the guide member 20 without the auto-focusing driver 50. In this case, a damping effect may be obtained between the lens barrel 10 and the guide member.

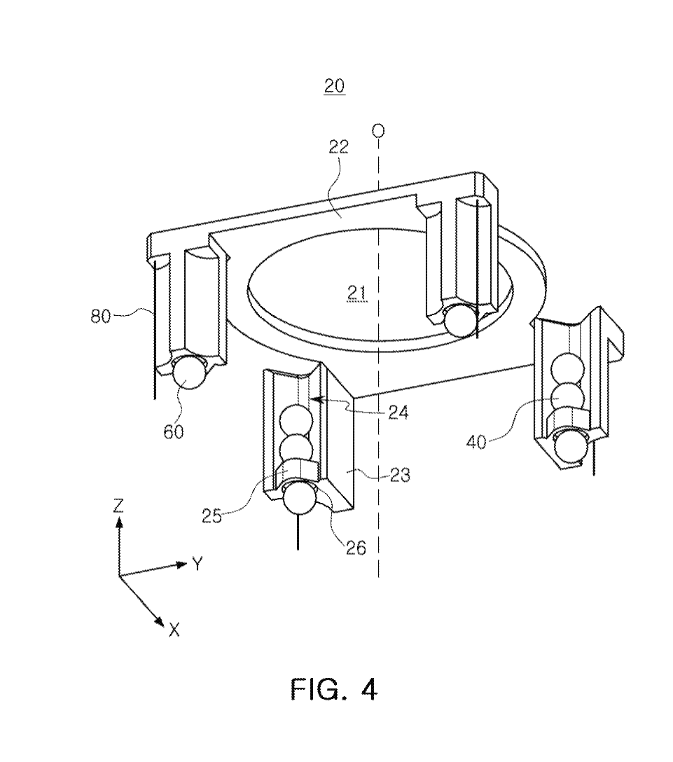

FIG. 4 illustrates two first ball members 40 are provided at the corresponding leg part 23, but the description is not limited thereto.

However, if too few first ball members, or just one ball member is provided at each leg part, the lens barrel 10 may be inclined, or misaligned, with respect to the optical axis, and thus a driving tilt is likely to occur. If too many first ball members are provided at each leg part, the reduction of size of the camera module may be adversely affected. In other words, too many ball members would increase the overall size of the camera module. Therefore, the lens driving device 1 comprises an appropriate number ball members 40, for example, about two to four. Thus, the lens barrel 10 may smoothly move along the optical axis direction inside the guide member 20 by the first ball member 40.

As described above, the auto-focusing driver 50 is disposed between the pair of leg parts 23 on one side of the guide member 20. Here, the auto-focusing driver 50 drives the lens 11 along the optical axis direction to focus an image onto the image sensor 2.

The auto-focusing driver 50 drives the lens barrel 10 along the optical axis direction, and may be a voice coil motor (VCM) scheme using an electromagnetic force of a coil and a magnet, an ultrasonic motor scheme using piezoelectricity, or a driving scheme applying a current to a wire of a shape memory alloy.

The following embodiment will be described based on the VCM scheme, but the scope of the present disclosure is not limited thereto. The auto-focusing driver 50 includes a first printed circuit board (PCB) 51, a first coil 52 coupled to one side of the first PCB, and a yoke 53 coupled to the other side of the first PCB 51 and fixed to the pair of leg parts 23 positioned on one side of the guide member 20.

One of the plurality of magnets of the lens barrel 10, that is, the first magnet 12, is disposed opposite to the first coil 52 provided on one side of the guide member 20. The yoke 53, formed of a magnetic material, is fixed to the pair of adjacent leg parts 23 by, for example, bonding or an adhesive, and the first magnet 12 of the lens barrel 10 applies an attractive force to the yoke 53. One side of the first PCB 51 is coupled to the yoke 53 between the pair of leg parts 23 and the other side thereof is mounted with the first coil 52. The first PCB 51 provides a driving current to the auto-focusing driver 50, in detail, the first coil 52. The first coil 52 may be a winding coil or a multi layered coil board.

The first magnet 12 generates a constant magnetic field and when a current is applied to the first coil 52, a Lorentz force is generated by the electromagnetic force interaction between the first magnet and the first coil. The Lorentz force drives first magnet 12 which is attached to the lens barrel 10 along the optical axis direction. By this operation, the auto-focusing driver 50 moves the lens barrel 10 to perform the auto-focusing function or a zoom function.

A hall sensor (not illustrated) is disposed on an inner side of a winding of the first coil 52 to sense a change in the magnetic field from the first magnet 12. The hall sensor senses the change in the magnetic field from the first magnet 12 to transfer a signal to a driver integrated circuit (IC) for driving the auto-focusing driver 50 through the first PCB 51.

Referring to FIG. 4, a receiving groove 26, configured to receive a portion of a second ball member, or bearing, 60, is disposed in a distal end, relative to the opening part 21, of each leg part 23 of the guide member 20. The second ball member 60 contacts a surface of the base 30 and is configured to roll within the receiving groove 26 when the guide member 20 is moved in a direction orthogonal to the optical axis. Therefore, the second ball member 60 is disposed between the guide member 20 and the base 30 in order to support the guide member.

At least a portion of the second ball member 60 is outside of the receiving groove 26. Therefore, the guide member 20 and the base 30 are spaced apart from each other at a predetermined interval by the second ball member.

The guide member 20 is indirectly supported by the base 30 through the second ball member 60. Thus when the guide member 20, which holds and supports the lens barrel 10 therein, is moved in a direction orthogonal to the optical axis (or in the X-Y plane), the base always point-contacts the each of the second ball members 60. Therefore, the guide member is stable as it is moved in a direction orthogonal to the optical axis. In other words, the guide member 20 and the lens barrel 10 are disposed on the base 30 and thus can move relative to the base 30 in a direction orthogonal to the optical axis. The first ball member 40 and the second ball member 60 may comprise a plastic such as polyurethane, a metal such as aluminum, or carbon, or any combination thereof.

The guide member 20 and the lens barrel 10 are disposed in the base 30, and are able to move within the X-Y plane with respect to the base 30. In order to correct for user hand-shake, a hand-shake prevention driver 70 is be disposed on the base. The hand-shake prevention driver 70 is used to correct image blurring due to the lens 11 shaking in the direction orthogonal to the optical axis, in other words in the X-Y plane, caused by user hand-shake during image capturing.

When hand-shake occurs during image capturing, an optical image stabilization (OIS) technology is applied to perform the optical image stabilization. The OIS technology corrects the mismatch of light passing through the lens with the optical axis of the lens by moving the lens in a direction towards the optical axis to align the optical axis of the lens with an incident path of light. Alternatively, the OIS technology moves the image sensor in the direction towards the optical axis to align the optical axis with the incident path of light received by the image sensor to perform the optical image stabilization. In other words, the OIS technology moves either the lens or the image sensor in the direction (X direction and Y direction) orthogonal to the optical axis, which is at a right angle to the optical axis direction (Z direction) to perform the optical image stabilization.

For this purpose, as long as the hand-shake prevention driver 70 drives the lens 11 in a direction orthogonal to the optical axis, like the auto-focusing driver 50, the driving scheme of the hand-shake prevention driver 70 may be varied.

The hand-shake prevention driver 70 according to an embodiment includes a second PCB 71 fixed to a side wall 31 of the base 30 and a second coil 72 coupled to one side of the second PCB 71. The guide member 20 and the lens barrel 10 are driven in a direction orthogonal to the optical axis by three hand-shake prevention drivers 70, disposed on three side walls 31 of the base 30, respectively.

Three side surfaces of the lens barrel 10 are provided with the second magnets 13 and the second magnets 13 supported by the lens barrel are disposed opposite to the second coils 72. The second magnets 13 of the lens barrel 10 respectively correspond to the second coils 72 provided on the side walls 31. Further, the respective second coils 72 are disposed on the side walls 31 of the base 30 opposite to the corresponding second magnets 13 while spaced apart in the direction orthogonal to the optical axis from second magnets 13.

An opening 32 is provided in each side wall 31 to accommodate each second coil 72 mounted on each second PCB 71, respectively. The opening 32 is covered with the second PCB 71.

The second PCB 71 provides a driving current to the hand-shake prevention driver 70, in detail, the second coil 72. Here, like the first coil 52, the second coil 72 may also be the winding coil or the multi layered coil board.

Through electromagnetic interaction, the second coil 72 and the second magnet 13, disposed opposite to each other, generate a Lorentz force when a current is applied to the second coil 72. The lens barrel 10 is driven in a direction orthogonal to the optical axis by the Lorentz force. Thus, the hand-shake prevention driver 70 moves the lens barrel 10 to correct a deviation in the lens barrel occurring in a direction orthogonal to the optical axis.

Further, a hall sensor (not illustrated) is disposed on the inner side of the winding of the second coil 72 to sense the change in the magnetic field from the second magnet 13. Two hall sensors may be used to determine the positions in the X direction and the Y direction. The hall sensors sense a change in the magnetic field from the second magnet 13 and transfers a signal to a driver IC, for driving the hand-shake prevention driver 70 through the second PCB 71.

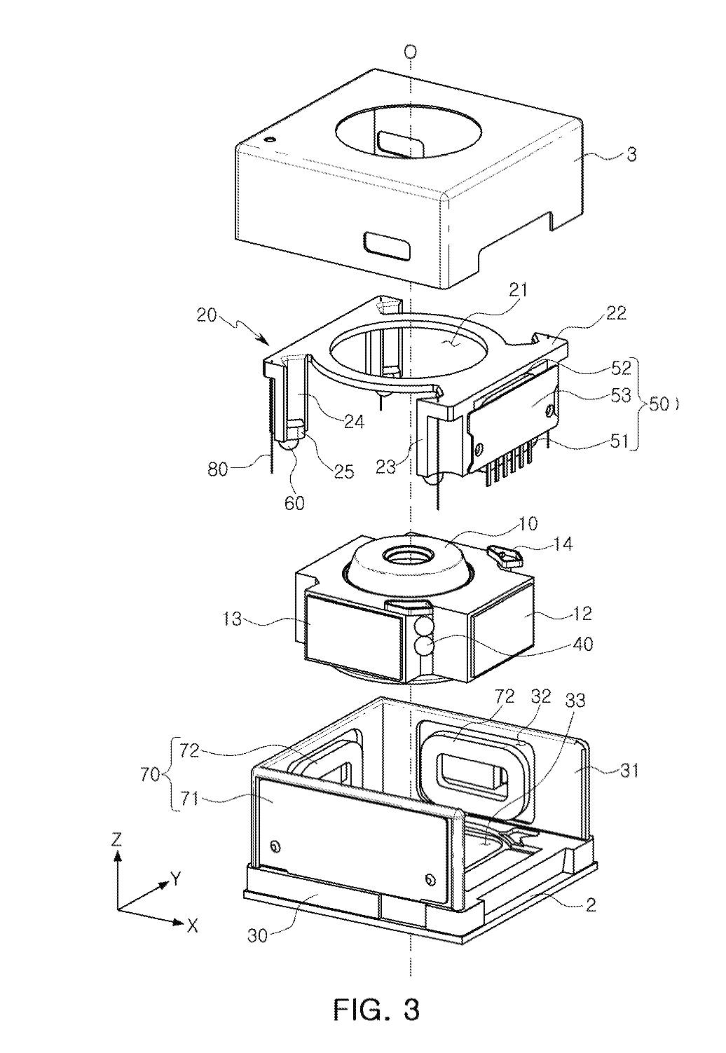

The hand-shake prevention drivers 70 are disposed on sides of the base 30 other than the side on which the auto-focusing driver 50 is disposed. Referring to FIG. 3, the base 30 is approximately a square board member in which a through hole 33 is formed, the hand-shake prevention drivers 70 are disposed on three sides of the base and the foregoing auto-focusing driver 50 is disposed on the remaining side.

The base 30 supports the guide member 20 and is coupled to a shield case 3 having a through hole as described above to form the appearance of the camera module and protect internal components.

Further, the image sensor 2 is mounted on the side of the base 30 opposite the guide member 20.

In addition, an elastic member 80 connected between the guide member 20 and the base 30 is disposed along the leg part 23 of the guide member or disposed adjacent to the leg part, parallel to the optical axis direction. The elastic member 80 may have a wire shape. One end thereof may be inserted into insertion holes formed at each corner of the guide member 20 and bonded thereto by, for example, soldering or an adhesive. The other end of the elastic member 80 is inserted into insertion holes formed at each corner of the base 30 and bonded thereto by, for example, soldering or an adhesive. When the guide member 20 moves in a direction orthogonal to the optical axis with respect to the base 30, the elastic member 80 elastically supports the guide member or the base.

Further, one end of the elastic member 80 may be bonded to the guide member 20 and the other end thereof may be bonded to the base 30, such that the elastic member 80 may also serve to maintain a gap, in the optical axis direction, between the guide member 20 and the base 30. In other words, the guide member 20 and the base 30 are supported in the optical axis direction by the elastic member 80 disposed in parallel with the optical axis direction in the state in which they are held apart at a predetermined interval. Therefore, the guide member 20 and the base 30 are held apart at a predetermined interval by the elastic member 80, such that the second ball member 60 may continuously roll without being separated between the guide member 20 and the base 30.

As set forth above, the camera module includes both an auto-focusing function and an optical image stabilization function by moving the lens in the optical axis direction and a direction orthogonal to the optical axis. According to one or more embodiments, it is possible to reduce the number of components, thereby making the camera module compact.

Ultimately, it is possible to further reduce the number of components required in the camera module and simplify the assembling process than before, thereby saving the manufacturing costs.

As a non-exhaustive example only, a device as described herein may be a mobile device, such as a cellular phone, a smart phone, a wearable smart device (such as a ring, a watch, a pair of glasses, a bracelet, an ankle bracelet, a belt, a necklace, an earring, a headband, a helmet, or a device embedded in clothing), a portable personal computer (PC) (such as a laptop, a notebook, a subnotebook, a netbook, or an ultra-mobile PC (UMPC), a tablet PC (tablet), a phablet, a personal digital assistant (PDA), a digital camera, a portable game console, an MP3 player, a portable/personal multimedia player (PMP), a handheld e-book, a global positioning system (GPS) navigation device, or a sensor, or a stationary device, such as a desktop PC, a high-definition television (HDTV), a DVD player, a Blu-ray player, a set-top box, or a home appliance, or any other mobile or stationary device capable of wireless or network communication. In one example, a wearable device is a device that is designed to be mountable directly on the body of the user, such as a pair of glasses or a bracelet. In another example, a wearable device is any device that is mounted on the body of the user using an attaching device, such as a smart phone or a tablet attached to the arm of a user using an armband, or hung around the neck of the user using a lanyard.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A lens driving device, comprising:
a lens barrel;
a lens disposed in the lens barrel;
a plurality of magnets disposed on an external surface of the lens barrel;
a guide member coupled to the lens barrel and configured to move the lens barrel in an optical axis direction;
a first coil disposed on one side of the guide member opposite to one of the plurality of magnets;
a base supporting the guide member configured to move the guide member in a direction orthogonal to the optical axis direction; and
a second coil disposed on a side wall of the base opposite to a magnet which is not opposite to the first coil.

2. The lens driving device of claim 1, wherein the guide member comprises:
a main body;
an opening part disposed in the main body; and
a plurality of leg parts extending in optical axis direction from each corner of the main body.

3. The lens driving device of claim 2, wherein an auto-focusing driver, disposed on one side of the guide member, comprises:
a first printed circuit board;
the first coil coupled to one side of the first printed circuit board; and
a yoke fixed to two of the leg parts and another side of the first printed circuit board.

4. The lens driving device of claim 1, wherein a first ball member is interposed between the lens barrel and the guide member.

5. The lens driving device of claim 4, wherein one side of the lens barrel is provided with a stopper configured to prevent the first ball member from separating.

6. The lens driving device of claim 2, wherein the leg part of the guide member is provided with a concave part extending in a length direction of the leg part and a first ball member is disposed in the concave part, and
the first ball member is configured to contact the lens barrel while rolling between the magnets of the lens barrel.

7. The lens driving device of claim 6, wherein a plurality of first ball members are disposed in the concave part.

8. The lens driving device of claim 1, wherein a hand-shake prevention driver, disposed on a side wall of the base, comprises:
a second printed circuit board fixed to the side wall, wherein
the second coil is coupled to one side of the second printed circuit board.

9. The lens driving device of claim 1, wherein a second ball member is interposed between the guide member and the base.

10. The lens driving device of claim 2, wherein a receiving groove is disposed on an end of the leg parts distal to the opening part, and
a second ball member is disposed in the receiving groove and configured to contact the base.

11. The lens driving device of claim 1, further comprising:
an elastic member connecting the guide member to the base.

12. The lens driving device of claim 11, wherein the elastic member comprises a wire,
wherein one end of the elastic member is bonded to a corner of the guide member and another end of the elastic member is bonded to a corner of the base corresponding to the corner of the guide member.

13. The lens driving device of claim 12, further comprising an elastic member disposed between each corner of the guide member and base, respectively.

14. A camera module, comprising:
a lens driving device; and
an image sensor mounted in a base and corresponding to a position of a lens of the lens driving device, wherein
the lens driving device comprises:
a lens barrel;
a plurality of magnets disposed on an external surface of the lens barrel;
a guide member coupled to the lens barrel configured to move the lens barrel in an optical axis direction;
a first coil disposed on one side of the guide member opposite to one of the plurality of magnets;
the base configured to support the guide member and move the guide member in a direction orthogonal to the optical axis direction; and
a second coil disposed on a side wall of the base opposite to a magnet which is not opposite to the first coil.

15. The camera module of claim 14, wherein the lens driving device is coupled to a shield case having a through hole.

16. The camera module of claim 14, wherein a first ball member is interposed between a lens barrel and a guide member of the lens driving device.

17. The camera module of claim 16, wherein a second ball member is interposed between the guide member and the base of the lens driving device.

18. A lens driving device comprising:
a lens barrel;
magnets disposed on an external surface of the lens barrel;
a plurality of concave parts, extending in an optical axis direction, disposed in the lens barrel between each of the magnets, respectively;
a guide member, configured to support the lens barrel, comprising a main body and a plurality of leg extending in the optical axis direction from the main body, wherein the plurality of legs corresponds to the plurality of concave parts;
a first coil disposed on a side of the guide member corresponding to one of the magnets; and
a base configured to support the guide member.

19. The lens driving device of claim 18, further comprising
a stopping part disposed on each of the plurality of legs, distal from the main body;
a stopper disposed on each the lens barrel, adjacent to the concave parts; and
a first ball member disposed between the plurality of legs and the plurality of concave parts,
wherein the stopping part and the stopper are configured to prevent the first ball member from separating.

20. The lens driving device of claim 19, wherein the guide member supports the stopping part and first ball member, and the stopping part and first ball member support lens barrel.
